(19) United States
(12) Patent Application Publication
(10) Pub. No.: US 2012/0085747 A1
(43) Pub. Date: Apr. 12, 2012

(54) HEATER ASSEMBLY AND WAFER PROCESSING APPARATUS USING THE SAME

(76) Inventors: Benson CHAO, Hsinchu City (TW); Tsan-Hua HUANG, Tainan City (TW)

(21) Appl. No.: 12/899,916

(22) Filed: Oct. 7, 2010

(51) Int. Cl. H05B 3/02; H05B 3/68

(52) U.S. Cl. 219/438; 219/444.1

(57) ABSTRACT

A heater assembly and a wafer processing apparatus using the same are provided. The heater assembly comprises a substrate, a heater, a reflector and a protective layer. The substrate has a top surface, a side surface surrounding the top surface and a trench formed on the top surface. The heater comprises a heater element accommodated within the trench and two electrodes respectively connecting two ends of the heater element and extending outside of the substrate. The reflector covers an inner surface of the trench. The protective layer covers the top surface, the side surface and the trench.

### FIELD OF THE INVENTION

The present invention generally relates to a wafer processing apparatus, and more particularly to a heater assembly for a wafer processing apparatus.

### DESCRIPTION OF THE RELATED ART

In semiconductor fabrication, it is important to modulate a temperature of a wafer, such as to heat the wafer or to maintain the temperature of the wafer, and thus deposition or growth of materials and selective removal or modification of the deposited/grown materials are controllable. In practice, a heater assembly located within a chamber is usually used for the above-mentioned purpose.

For example, the wafer may be held and heated to a predetermined temperature by the heater assembly within the chamber first. After that, the wafer may be maintained at the predetermined temperature, and thus a material may be deposited on the wafer with desired deposition parameters by a chemical vapor deposition (CVD) process, such as metal organic chemical vapor deposition (MOCVD), plasma enhanced chemical vapor deposition (PECVD), high density plasma chemical vapor deposition (HDP-CVD), expanding thermal plasma chemical vapor deposition (ETP-CVD), thermal plasma chemical vapor deposition (TPCVD), etc.

Note that a heater of the conventional heater assembly is usually directly exposed in the chamber and some matters provided or generated in the chamber may be harmful to the heater. For example, the heater may be damaged by plasma attacks or chemicals used in the cleaning process. Accordingly, it is highly desirable to protect the heater against damage, so as to enhance the lifetime of the heater.

### SUMMARY OF THE INVENTION

The present invention is directed to a heater assembly and a wafer processing apparatus using the same, wherein the protective layer may protect the heater against a mechanical damage.

The present invention provides a heater assembly formed integrally and monolithically for a wafer processing apparatus comprising a substrate, at least a heater, a reflector and a protective layer. The substrate has a top surface, a side surface surrounding the top surface and at least a trench formed on the top surface with a predetermined pattern. The heater comprises a heater element accommodated within the trench and two electrodes respectively connecting two ends of the heater element and extending outside of the substrate. The reflector covers a bottom surface of the trench. The protective layer covers the top surface, the side surface and the trench.

The present invention further provides a wafer processing apparatus comprising a chamber, a spindle comprising a carrier and a shaft and the above-mentioned heater assembly. The carrier is disposed within the chamber and having a first side and a second side opposite to the first side. The shaft passes through a wall of the chamber and an end thereof within the chamber connects the first side. The heater assembly formed integrally and monolithically may be fixed on the second side as a bottom surface of the substrate facing the second side, and the two electrodes electrically connect to a power supply located outside of the chamber via the spindle.

According to an embodiment of the present invention, the substrate is made by a ceramic sintering process or a CVD process and the trench is formed by machining the top surface of the substrate.

According to an embodiment of the present invention, a material of the substrate is AlN or Al₂O₃ when a heating temperature of the heater is lower than 1000° C. and is SiC, BN (boron nitride) or PBN (pyrolytic boron nitride) when a heating temperature of the heater is higher than 1000° C.

According to an embodiment of the present invention, a material of the heater is graphite, W, SiC or Mo.

According to an embodiment of the present invention, the electrodes connect two ends of the heater element respectively.

According to an embodiment of the present invention, the electrodes pass through the bottom surface.

According to an embodiment of the present invention, the reflector is made by BN or PBN on metal-based materials.

According to an embodiment of the present invention, the protective layer further covers side surfaces of the trench.

According to an embodiment of the present invention, the protective layer is made by a thin film coating process and capable of standing the temperature of the heater.

According to an embodiment of the present invention, materials of the substrate and the protective layer are the same.

According to an embodiment of the present invention, outer surfaces of the protective layer are flat surfaces.

According to an embodiment of the present invention, a thickness of the protective layer ranges inclusively between 0.1 mm and 2 mm.

In contrast to the conventional heater assembly, the heater of the present invention is covered by the protective layer, and thus the protective layer may protect the heater against plasma attacks and chemicals.

### BRIEF DESCRIPTION OF THE DRAWINGS

FIG. 1A illustrates a schematic view of a wafer processing apparatus according to an embodiment of the present invention.

FIG. 1B illustrates an explosion view of the heater assembly as illustrated in FIG. 1A.

FIGS. 2A to 2D illustrate different schematic layouts of the heaters designed on the substrates according to different embodiments of the present invention.

### DETAILED DESCRIPTION OF THE INVENTION

Reference will now be made in detail to specific embodiments of the present invention. Examples of these embodiments are illustrated in the accompanying drawings. While the invention will be described in conjunction with these specific embodiments, it will be understood that it is not intended to limit the invention to these embodiments. In fact, it is intended to cover alternatives, modifications, and equivalents as may be included within the spirit and scope of the invention as defined by the appended claims. In the following description, numerous specific details are set forth in order to provide a through understanding of the present invention. The present invention may be practiced without some or all of these specific details. In other instances, well-known process operations are not described in detail in order not to obscure the present invention.

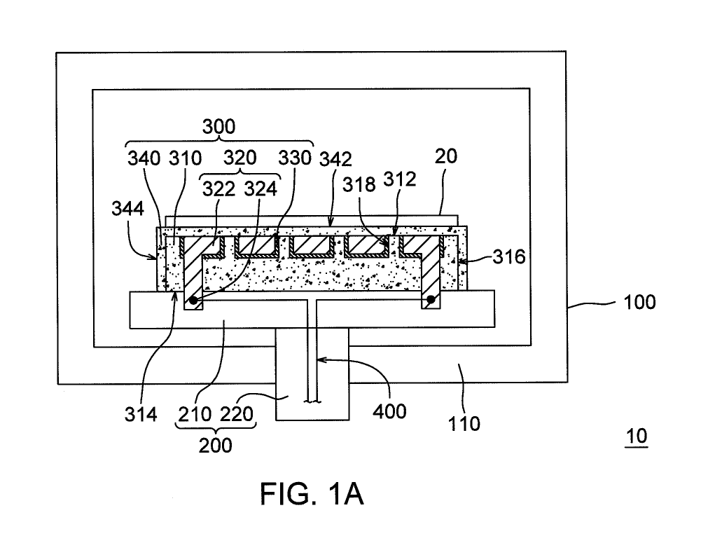

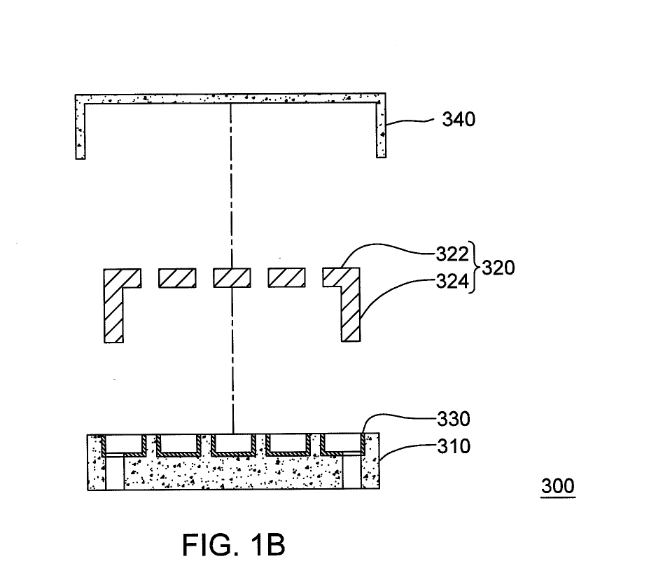

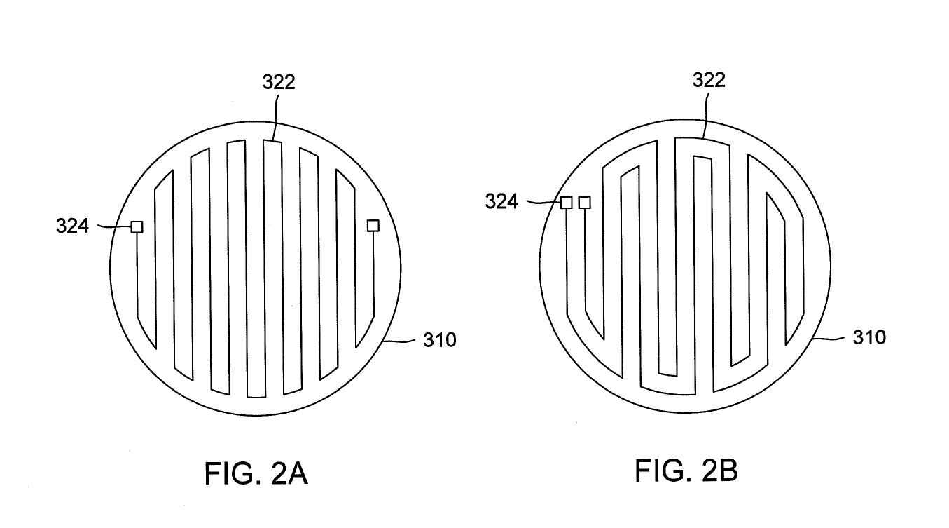

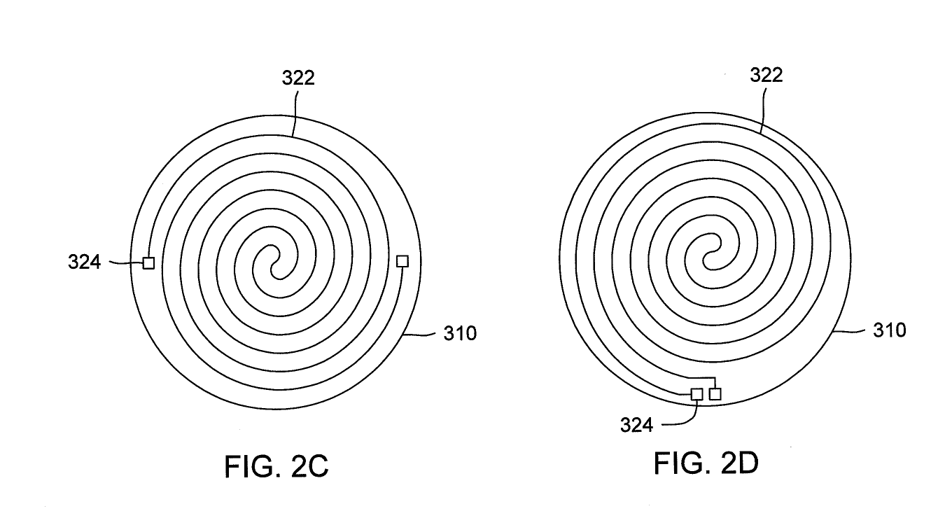

FIG. 1A illustrates a schematic view of a wafer processing apparatus according to an embodiment of the present invention, FIG. 1B illustrates an explosion view of the heater assembly as illustrated in FIG. 1A, and FIGS. 2A to 2D illustrate different schematic layouts of the heaters designed on the substrates according to different embodiments of the present invention. Referring to FIG. 1, the wafer processing apparatus 10 for modulating a temperature of a wafer 20, for example heating a wafer 20 or maintaining a temperature of a wafer 20, is composed of a chamber 100, a spindle 200 and a heater assembly 300. A carrier 210 of the spindle 200 is disposed within the chamber 100. In addition, a shaft 220 of the spindle 200 passes through a bottom wall 110 of the chamber 100 from outside of the chamber 100 to connect a bottom side of the carrier 210. Further, the heater assembly 300 may be fixed on a top side of the carrier 210 by fasteners (not shown), such as screws, clamps, etc.

The heater assembly 300 is formed integrally and monolithically and comprises a substrate 310, a heater 320, a reflector 330 and a protective layer 340. The substrate 310 has a top surface 312, a bottom surface 314, a side surface 316 and a trench 318. The bottom surface 314 is opposite to the top surface 312 and faces the top side of the carrier 210 when the heater assembly 300 is fixed on the carrier 210. The side surface 316 surrounds and connects between the top surface 312 and the bottom surface 314. The trench 318 is formed on the top surface 312 with a predetermined pattern. In the present embodiment, the substrate 310 may be made by a ceramic sintering process or a CVD process and the trench 318 may be formed by machining the top surface 312.

Furthermore, the heater 320 includes a heater element 322 and two electrodes 324. The heater element 322, for example a wire, is accommodated within and supported well by the trench 318 to form an electrical flow with the predetermined pattern. Each of the electrodes 324 connects an end of the heater element 322 and may further pass through the bottom surface 314 to extend outside of the substrate 310. In the present embodiment, the electrodes 324 may electrically connect to a power supply (not shown) located outside of the chamber 100 via wires 400 passing through the spindle 200, and thus the wafer 20 may be uniformly heated by the heater element 322. Note that if a heating temperature of the heater 320 is lower than 1000° C., it is recommended to choose AlN, Al₂O₃ or SiC for being a material of the substrate 310. In contrary, if a heating temperature of the heater 320 is higher than 1000° C., it is recommended to choose SiC, BN (boron nitride) or PBN (pyrolytic boron nitride) for being a material of the substrate 310. In addition, the heater 320 may be made by metal or non-metal based materials, such as graphite, W, SiC or Mo, and machined to form the required shape, cross-section and resistivity.

Note that the top view of the schematic layout of the heater element 322 designed on the substrate 310 may be a serpentine geometry with locating the electrodes 324 at two opposite sides of the substrate 310 as illustrated in FIG. 2A or the same side of the substrate 310 as illustrated in FIG. 2B, a spiral geometry with locating the electrodes 324 at two opposite sides of the substrate 310 as illustrated in FIG. 2C or the same side of the substrate 310 as illustrated in FIG. 2D, or any other proper layouts. In addition, both numbers of the trench 318 and the heater 320 are only one in the present embodiments for providing single heating zone, but may be two or more in other un-illustrated embodiments for providing multiple heating zones. Besides, the electrodes in other un-illustrated embodiments may connect between two ends of the heater element, and thus only a portion of the heater element between the electrodes may use for heating the wafer.

Moreover, the reflector 330 covers a bottom surface of the trench 318, but covering both the bottom surface and the side surfaces of the trench 318 is preferred, and may be made by BN or PBN on metal-based materials which may sustain a higher temperature. Therefore, the heat generated by the heater 320 may be reflected towards designed directions, such as upward, to be used more efficiency, instead of being transmitted towards non-design directions, such as downward or sideward, to be wasted.

In addition, the protective layer 340 may be made by a thin-film coating process, such as a CVD process, to cover the top surface 312, the side surface 316, the trench 318, the heater element 322 and the reflector 330 with a thickness ranges inclusively between 0.1 mm and 2 mm, and is capable of standing the temperature of the heater 320. In the present embodiment, outer surfaces of the protective layer 340, including a top surface 342 and a side surface 344, may be flat surfaces to form uniform heat surface distribution. Further, the protective layer 340 may be made by a material similar to or the same as the material of the substrate 310, so as to have similar or the same coefficient of thermal expansion (CTE) and thermal conductivity as the substrate 310.

In contrast to the conventional heater exposed in the chamber directly, the heater element 322 of the present invention is enclosed by the substrate 310 and the protective layer 340, and thus the heater element 322 may be protected against a mechanical damage, such as attacks by plasma or chemicals used in the cleaning process.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

What is claimed is:

1. A heater assembly formed integrally and monolithically for a wafer processing apparatus, comprising:
a substrate having a top surface, a side surface surrounding the top surface and at least a trench formed on the top surface with a predetermined pattern;
at least a heater comprising:
a heater element accommodated within the trench; and
two electrodes respectively connecting the heater element and extending outside of the substrate;
a reflector covering a bottom surface of the trench; and
a protective layer covering the top surface, the side surface and the trench.

2. The heater assembly as claimed in claim 1, wherein the substrate is made by a ceramic sintering process or a CVD process and the trench is formed by machining the top surface of the substrate.

3. The heater assembly as claimed in claim 1, wherein a material of the substrate is AlN or Al₂O₃ when a heating temperature of the heater is lower than 1000° C. and is SiC, BN or PBN when a heating temperature of the heater is higher than 1000° C.

4. The heater assembly as claimed in claim 1, wherein a material of the heater is graphite, W, SiC or Mo.

5. The heater assembly as claimed in claim 1, wherein the electrodes connect two ends of the heater element respectively.

6. The heater assembly as claimed in claim 1, wherein the electrodes pass through a bottom surface of the substrate opposite to the top surface.

7. The heater assembly as claimed in claim 1, wherein a material of the reflector is made by BN or PBN on metal-based materials.

8. The heater assembly as claimed in claim 1, wherein the protective layer further covers side surfaces of the trench.

9. The heater assembly as claimed in claim 1, wherein the protective layer is made by a thin film coating process and capable of standing the temperature of the heater.

10. The heater assembly as claimed in claim 1, wherein materials of the substrate and the protective layer are the same.

11. The heater assembly as claimed in claim 1, wherein outer surfaces of the protective layer are flat surfaces.

12. The heater assembly as claimed in claim 1, wherein a thickness of the protective layer ranges inclusively between 0.1 mm and 2 mm.

13. A wafer processing apparatus, comprising:
a chamber;
a spindle comprising:
a carrier disposed within the chamber and having a first side and a second side opposite to the first side; and
a shaft passing through a wall of the chamber, wherein an end of the shaft within the chamber connects the first side;
a heater assembly formed integrally and monolithically, capable of being fixed on the second side and comprising:
a substrate having a bottom surface facing the second side, a top surface opposite to the bottom surface, a side surface surrounding the top surface and the bottom surface, and at least a trench formed on the top surface with a predetermined pattern;
at least a heater comprising:
a heater element accommodated within the trench; and
two electrodes respectively connecting the heater element, extending outside of the substrate, and electrically connected to a power supply located outside of the chamber via the spindle;
a reflector covering a bottom surface of the trench; and
a protective layer covering the top surface, the side surface and the trench.

14. The wafer processing apparatus as claimed in claim 13, wherein the substrate is made by a ceramic sintering process or a CVD process and the trench is formed by machining the top surface of the substrate.

15. The wafer processing apparatus as claimed in claim 13, wherein a material of the substrate is AlN or Al₂O₃ when a heating temperature of the heater is lower than 1000° C. and is SiC, BN or PBN when a heating temperature of the heater is higher than 1000° C.

16. The wafer processing apparatus as claimed in claim 13, wherein a material of the heater is graphite, W, SiC or Mo.

17. The wafer processing apparatus as claimed in claim 13, wherein the electrodes connect two ends of the heater element respectively.

18. The wafer processing apparatus as claimed in claim 13, wherein the electrodes pass through the bottom surface.

19. The wafer processing apparatus as claimed in claim 13, wherein the reflector is made by BN or PBN on metal-based materials.

20. The wafer processing apparatus as claimed in claim 13, wherein the protective layer further covers side surfaces of the trench.

21. The wafer processing apparatus as claimed in claim 13, wherein the protective layer is made by a thin film coating process and capable of standing the temperature of the heater.

22. The wafer processing apparatus as claimed in claim 13, wherein materials of the substrate and the protective layer are the same.

23. The wafer processing apparatus as claimed in claim 13, wherein outer surfaces of the protective layer are flat surfaces.

24. The wafer processing apparatus as claimed in claim 13, wherein a thickness of the protective layer ranges inclusively between 0.1 mm and 2 mm.
